(19) United States
(12) Patent Application Publication
(10) Pub. No.: US 2026/0099738 A1
(43) Pub. Date: Apr. 9, 2026

(54) PROBABILISTIC PROGRAMMING APPROACH TO INTENTION ESTIMATION IN HUMAN-ROBOT TELEOPERATED ASSEMBLY TASKS

(71) Applicant: Honda Motor Co., Ltd., Tokyo (JP)

(72) Inventors: Aolin XU, Santa Clara, CA (US); Songpo LI, San Jose, CA (US); Prakash BASKARAN, San Jose, CA (US); Karankumar Ashokbhai PATEL, San Jose, CA (US); Soshi IBA, Mountain View, CA (US)

(73) Assignee: Honda Motor Co., Ltd., Tokyo (JP)

(21) Appl. No.: 19/053,736

(22) Filed: Feb. 14, 2025

Related U.S. Application Data
(60) Provisional application No. 63/705,411, filed on Oct. 9, 2024.

(51) Int. Cl. G06N 7/01; G06N 20/00

(52) U.S. Cl. CPC G06N 7/01; G06N 20/00

(57) ABSTRACT

A method for probabilistic modeling for intention estimation in an operator-robot teleoperated assembly task is provided. The method may estimate the assembly task to be completed, wherein the assembly task comprises a sequence of actions. The method may predict a next action of the sequence of actions to be performed for the assembly task to be completed.

### RELATED APPLICATIONS

This patent application is related to U.S. Provisional Application No. 63/705,411 filed Oct. 9, 2024, entitled “Probabilistic Programming Approach to Intention Estimation in Human-Robot Teleoperated Assembly Tasks”, in the names of the same inventors which is incorporated herein by reference in its entirety. The present patent application claims the benefit under 35 U.S.C § 119(e) of the aforementioned provisional application.

### BACKGROUND

Despite having the advantages of remote access and precise operation, human-robot teleoperation may be challenging for operators. For example, completing complex tasks or executing highly accurate actions may be especially challenging for the operators. Increasing the robot intelligence and autonomy level may allow robots to better assist the operator in achieving the desired goal. An important aspect of robot intelligence may be the ability to estimate the operator's intention. Most existing works may focus on estimating the intended object or the location the operator may be approaching. Limited work may be available that may consider the task or action level intentions, even though knowing the task and action intentions may be important for determining how the robot operations may be provided.

Many works in intention estimation for teleoperation may focus on estimating the object or location the operator is trying to approach, and the reference therein, or the operator's motions for manipulation of the robot, without consideration of the task being completed or the actions toward the goal of task completion. Some recent works may have started to consider task and action level intentions, which may emphasize the need to know or estimate the task and action which may lead one to carry out effective robot operations. In some recent works, one may develop a deep learning-based method to estimate the task and recognize the current action in an assembly work. Benefited from the hierarchy dependency loss function, good estimation and recognition accuracy may be achieved. However, as in all data-driven methods, a large amount of data may need to be collected and annotated to train such a model. In addition, estimating uncertainties and predicting the future actions may be challenging for this type of method as it may require different training objectives.

Probabilistic graphical models, such as Bayesian Network (BN), Hidden Markov Models (HMM), Dynamic Bayesian Network (DBN) and their variants, may be used for intention, location or target estimations. In some works, BNs may be used for modeling the location intentions, and both structure and parameters of the networks may be learned from data. In contrast, in the present method disclosed below, one may fix the model structure with domain knowledge and carry out parameter learning, which may be used to obtain higher accuracy and efficiency in task and action level intention estimations. In some works, the HMM may be augmented with a task variable to increase its representation power, but the model is time-invariant, such that the same transition and observation distributions may be applied to all latent states and observations across time. In some works, a similar HMM may be used for gaze-assisted intention estimation. In some works, a hierarchical DBN may be used to estimate the target location and whether the robot may be needed to operate, but the model may be time-invariant and may be predefined without training. Compared with the large volume of existing HMM and DBN based methods including the above identified ones, the distinctive feature of the present method may be that the present method may explicitly model each individual distribution, such that actions occurring at different times may be generated by different distributions. Also, the present model may be able to handle non-uniform time steps between two consecutive actions, whereas the HMM and DBN may often work with a uniform time steps between the temporal nodes.

Probabilistic programming languages have been used in robotics for planning, control, trajectory generation, and modeling. However, its usage in intention estimation for teleoperated assembly tasks appears to be unexplored before.

Limitations and disadvantages of conventional and traditional approaches will become apparent to one of skill in the art, through comparison of described method with some aspects of the present disclosure, as set forth in the remainder of the present application and with reference to the drawings.

### SUMMARY

According to an embodiment of the disclosure, a method for probabilistic modeling for intention estimation in an operator-robot teleoperated assembly task is provided. The method may estimate the assembly task to be completed, wherein the assembly task comprises a sequence of actions. The method may predict a next action of the sequence of actions to be performed for the assembly task to be completed.

According to another embodiment of the disclosure, a method for probabilistic modeling for intention estimation in an operator-robot teleoperated assembly task, the method implemented using a computer system including a processor communicatively coupled to a memory device is provided. The method may estimate the assembly task to be completed, wherein the assembly task comprises a sequence of actions. The method may predict a next action of the sequence of actions to be performed for the assembly task to be completed. The method may form a probabilistic graphical model to represent a joint distribution of the assembly task and all actions needed to be taken to complete the assembly task, wherein probabilistic graphical model learning is done through variation and probabilistic graphical model inference is done through structured marginalization.

According to another embodiment of the disclosure, a method for probabilistic modeling for intention estimation in an operator-robot teleoperated assembly task is provided. The method may estimate the assembly task to be completed, wherein the assembly task comprises a sequence of actions. The method may predict a next action of the sequence of actions to be performed for the assembly task to be completed. The method may treat the assembly task and the sequence of actions as jointly distributed random variables. The method may construct a joint distribution of the random variables, wherein the joint distribution of the random variables comprises a model structure and model parameters, wherein the model structure reflects dependencies among the random variables and determines how the joint distribution factorizes into a product of individual distributions of the random variables, and individual distribution of each random variable is one of a marginal distribution of a specific random variable when not influenced by other random variables, or a transition distribution conditional on random variables that influence the specific random variable, wherein the model parameters includes marginal distribution and all the transition distributions. The method may represent each individual distribution as one of a single finite dimensional probability vector or multiple finite dimensional probability vectors, wherein each single finite dimensional probability vector and each multiple finite dimensional probability vectors are treated as random quantities. The method may find a posterior distribution of each single finite dimensional probability vector and each multiple finite dimensional probability vectors given the dataset, wherein finding the posterior distribution of each single finite dimensional probability vector and each multiple finite dimensional probability vectors given the dataset is calculated in Pyro via stochastic variational inference (SVI). The method may output recognized actions in continuous time with uniform sampling interval using an action recognition module, wherein the output is the same during execution of an action with sporadic recognition errors. The method may extract distinct actions from the recognized actions.

### BRIEF DESCRIPTION OF THE DRAWINGS

FIGS. 1A-1D show different steps of an exemplary teleoperation assembly task, in accordance with an embodiment of the disclosure;

FIG. 2 shows exemplary probabilistic graphical model (Bayesian network) of random variables under consideration, in accordance with an embodiment of the disclosure;

FIGS. 3A-3B show exemplary Pyro-rendered probabilistic graphical models of random variables occurring in model learning and model inference, in accordance with an embodiment of the disclosure;

FIG. 4 shows an exemplary discrete-time action sequence extraction, in accordance with an embodiment of the disclosure;

FIGS. 5A-5F show exemplary toy assembly tasks used for experiments, in accordance with an embodiment of the disclosure;

FIG. 6 shows an exemplary task estimation for one of the toy assembly task, in accordance with an embodiment of the disclosure;

FIG. 7 shows an exemplary task estimation for another toy assembly task, in accordance with an embodiment of the disclosure;

FIG. 8 shows an exemplary task estimation for another toy assembly task, in accordance with an embodiment of the disclosure;

FIG. 9 shows an exemplary task estimation and action prediction accuracy vs. fraction of observed actions, counted from a plurality of trials, in accordance with an embodiment of the disclosure;

FIG. 10 shows an exemplary action prediction for one of the toy assembly task, in accordance with an embodiment of the disclosure;

FIG. 11 shows an exemplary action prediction for another toy assembly task, in accordance with an embodiment of the disclosure;

FIG. 12 shows an exemplary action prediction for another toy assembly task, in accordance with an embodiment of the disclosure; and

FIG. 13 shows an exemplary task distribution estimation from HMM method, in accordance with an embodiment of the disclosure.

The foregoing summary, as well as the following detailed description of the present disclosure, is better understood when read in conjunction with the appended drawings. For the purposes of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

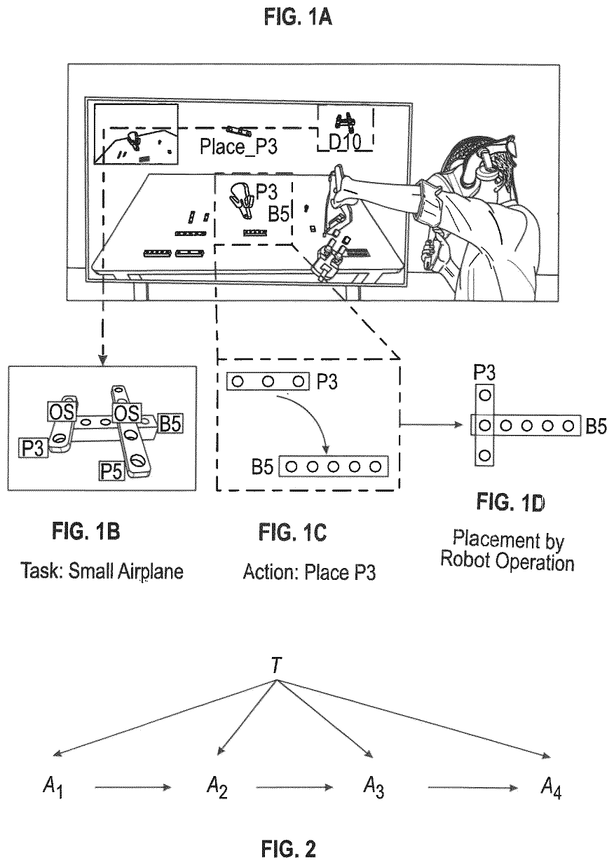

In the present method, one may consider the teleoperation for assembly tasks. Each task may be completed by taking a sequence of actions, and each action may involve acting in a certain way on an object. For example, as may be shown in FIGS. 1A-1D, to assemble a toy airplane, the object P3's middle hole may need to be aligned with the object B5's either left or right end, and the objects P3, B5 may need to form a cross-like shape. Knowing the simple location or motion intention may not be enough to describe the need for accomplishing the intended action. Actively estimating the task and the action on the other hand, may be used to determine what robot operation may be needed to carried out at each step to complete each action and finally the task.

In many assembly tasks, there may be ambiguities among the tasks to be completed, mostly due to the similarity, or the overlap, between the sequences of actions that may need to be taken to complete them. Considering this, probabilistic modeling of the tasks and actions may be beneficial for intention estimation, as such, models that may take the probabilistic dependencies among the variables into account, and have the potential to provide accurate estimations of the distributions of the variables of interest given the observations. This may motivate one to propose a new approach to the intention estimation problem by probabilistic modeling. One may use Pyro, a state-of-the-art probabilistic programming language (PPL) to carry out model construction, training and inference. Compared with the other PPLs which use Markov chain Monte-Carlo and clique tree for learning and inference, Pyro may generally achieve a better mix of flexibility and computational efficiency, as it may rely on variational inference and structured belief propagation for most of the probabilistic computation.

The contributions of the present method may be summarized as follows:
In this method, one may formulate and solve the problem of task and action level intention estimation, which may include task estimation and action prediction, rather than the location or motion prediction explored by many existing works.
In the present method, one may propose using a fine-grained probabilistic graphical model to represent the joint distribution of the task and actions. Both model learning and model inference may be carried out by Pyro, a state-of-the-art probabilistic programming language. Pyro may realize model learning by variational inference and model inference by structured marginalization, which may run highly efficiently on the present proposed model.
Unlike the traditional hidden Markov model (HMM) and dynamic Bayesian network (DBN) based methods that may be time-invariant, the proposed method may use the time information and explicitly model the individual distributions of the task and all the actions taken at different time in completing the task. By doing this, one may utilize the power of probabilistic programming and may achieve accurate distribution hence uncertainty estimations of the task and future actions, both immediate and long-horizon, which may not be achievable by HMM or pure deep learning-based methods.
Working with a pretrained action recognition module, the proposed method may be trained solely based on an instruction manual of the tasks, which may be composed of a tiny amount of data. When the tasks are changed or augmented, the same model may be retrained with negligible cost and the action recognition module may be reused. This is in contrast with the pure deep learning-based approach, which may rely on costly reannotation and retraining to accommodate changes or augmentations of the tasks.

In the assembly work, one may consider that there may be different tasks to complete. A task may be completed by taking a sequence of actions, and an action may involve acting upon an object. Though not required, the action sequences may be specified by an instruction manual, where one or multiple nominal action sequences may be assigned to each task. For example, in the toy assembly task shown in FIGS. 1A-1D, a task may be building a toy airplane, house, dragonfly, etc., an action may be to take the part B5, place B5, fasten a screw, etc., and the nominal action sequences of the tasks may be shown in each of the FIGS. 1A-1D. As a user is taking actions to complete a task, the goal of intention estimation may include estimating the task being completed and predicting the next action, both may be based on the observed actions taken by the user so far.

### Model

One may treat the task and the sequence of actions as jointly distributed random variables, denoted by T and A₁, . . . ,Aₙ. In practice, the action sequences of different tasks may have different lengths, one may simply append a number of END actions to the tasks other than the longest task, such that all the tasks have the same length n as the longest one, this may ease the present modelling. The modelling may refer to constructing a joint distribution of the random variables under consideration, it may involve two parts: model structure and model parameters.

The model structure may reflect the dependencies among the variables. It may determine how the joint distribution factorizes into the product of individual distributions of the variables. The individual distribution of each variable may be either the marginal distribution of that variable if it is not influenced by the other variables, or a transition distribution conditional on the variables that may influence it. This structure may be naturally described by a probabilistic graphical model, specifically a Bayesian network. An example structure one may consider may be shown in FIG. 2. This example may be a two-level structure, where the task may influence all the n actions in the sequence, also each action in the sequence may influence its immediate successor. According to the model structure, the joint distribution of all the random variables under consideration is described as

$${P}_{T , {A}_{1} , … , {A}_{n}} = {P}_{T} {P}_{{A}_{1} \vert T} {\prod }_{i = 2}^{n} {P}_{{A}_{i} \vert T , {A}_{i - 1}} . \qquad ( 1 )$$

The model parameters may include the marginal distribution PT and all the transition distributions P_{A}_{_{1/T}} and P_{A1}_{_{/T, Ai-1}}, i=2, . . . , n.

### Model Learning

Once the model structure may be specified, model learning may refer to learning the model parameters, that is, the unknown individual distributions, from a dataset. Since all the variables under consideration may only take a finite number of values, each individual distribution may be represented by one or multiple finite dimensional probability vectors, depending on whether it is a marginal or a transition distribution. From a Bayesian learning perspective, one may treat these vectors as random quantities and associate a Dirichlet prior to each of them. The model learning may then amount to finding the posterior distributions of these vectors given the dataset.

$$x = ( {x}_{1} , … , {x}_{m} ) \qquad ( 2 )$$

which may be m independent samples from the joint distribution given in (1), and may denote the unknown individual distributions collectively as

$$z = {P}_{T} , {P}_{{A}_{1} \vert T} , {P}_{{A}_{2} \vert T , {A}_{1}} , … , {P}_{{A}_{n} \vert T , {A}_{n} - 1} \qquad ( 3 )$$

which may be random vectors with Dirichlet priors; one may also denote the deterministic parameters of the Dirichlet priors collectively as θ. These quantities may specify a joint distribution

$${p}_{θ} ( x , z ) = {p}_{θ} ( z ) {\prod }_{k = 1}^{m} p ( {x}_{k} \vert z ) \qquad ( 4 )$$

where p_{θ(z)} may be the product of Dirichlet priors of the individual distributions, and p_{(xk/z)}=P_{T,A1, . . . , An}(xₖ) specified in (1) for all k=1, . . . , m. Model learning may then be computed

$${p}_{θ} ( z \vert x ) = \frac{{p}_{θ} ( x , z )}{\int {p}_{θ} ( x , {z}^{′} ) {dz}^{′}} . \qquad ( 5 )$$

This computation may be approximately carried out in Pyro via stochastic variational inference (SVI), where a surrogate Dirichlet distribution q_{φ}(z) for p_{θ}(z/x) parameterized by φ may be computed by maximizing the evidence lower bound (ELBO) over φ with θ fixed

$${arg}_{φ} max {E}_{{q}_{φ} ( z )} [ log {p}_{θ} ( x , z ) - log {q}_{θ} ( z ) ] \qquad ( 6 )$$

To do this, one may specify θ as a fixed tensor in the function model ( ) in Pyro, and specify φ as a Pyro learnable parameter pyro.param in the function guide ( ). The unknown variables in z may be specified as pyro.sample and may need to be defined in both model ( ) and guide ( ).

The target function in the form of (6) may be called as pyro.infer.Trace_ELBO ( ), and the SVI optimizer may be called as pyro.infer.SVI ( ). Within SVI, the Adam optimizer with a learning rate 0.0001 may be used to execute the variational optimization. Once the optimization converges, the optimized parameters φ of the approximated posterior q_{φ}(z) may be obtained from pyro.get_param_store ( ).items ( ).

One may vary both θ and φ and jointly optimize them by computing

$${arg max}_{θ , φ} {𝔼}_{{q}_{φ} ( z )} [ log {p}_{θ} ( x , z ) - log {q}_{φ} ( z ) ] , \qquad ( 7 )$$

which may amount to first finding the maximum likelihood θ given the data x as

$${θ}_{ML} = {arg}_{θ} max log {p}_{θ} ( x ) \qquad ( 8 )$$

and then compute the posterior distribution of z given x under θ_{ML}, that is p_{θML}(z/x). To do this, one may additionally specify θ as a Pyro learnable parameter pyro.param in the function model ( ), and the rest may be the same as above. Through experiments one may find that by fixing a proper θ and optimizing only φ one may already obtain accurate estimates of the individual distributions. Therefore one may use (6) for model learning, which may be computationally more efficient and stable compared to (7). For the model learning in the experiments disclosed below, the total training time may be around 30 minutes. In accordance with an embodiment, an Intel Core i7 1.8 GHz CPU may be used.

Once one may obtain the optimal q_{φ}(z) from (6) as an approximation of p_{θ}(z/x), one may use either their mean values or modes as the final estimates of the individual distributions. Through experiments, one may find that the modes may be more accurate estimates, so one may use their product, denoted by \hat{P}_{T.A1, . . . , An} as the estimated joint distribution. With \hat{P}_{T,A1, . . . . ,An}, one may be able to perform both task estimation and action prediction given the actions taken so far. Specifically, suppose the first i actions taken may be observed as (a₁, . . . , aᵢ), the distribution of the task being completed may be estimated as

$${\hat{P}}_{T \vert A 1 = a 1 , Ai = ai} , i = 1 , … , n \qquad ( 9 )$$

and the distribution of the next action may be predicted as

$${\hat{P}}_{Ai + 1 \vert A 1 = a 1 , Ai = ai} , i = 1 , … , n - 1 \qquad ( 10 )$$

Both conditional distributions may be computed via marginalizations of \hat{P}_{T,A1, . . . , An} in Pyro. From experiments one may see that the marginalization may be carried out efficiently to support real-time inference, achieving inference rate above 5 Hz on an Intel Core i7 1.8 GHz CPU for the experiments disclosed below. This may be due to both the designed structure of the model, where each individual distribution may be conditional on at most two variables, and the efficient structured marginalization algorithm implemented in Pyro.

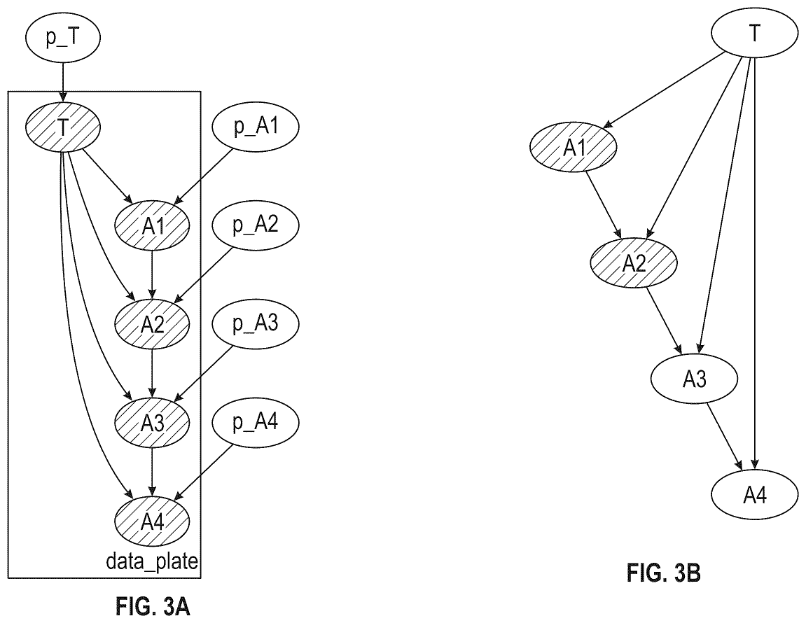

FIG. 3A-3B may show Pyro-rendered probabilistic graphical models of relevant random variables during learning and inference. The unobserved variables (unshaded) can be estimated from the observed ones (shaded). During learning FIG. 3A, the data samples drawn from the true joint distribution form a ‘data plate’, based on which the unknown individual distributions denoted as (p_T, p_A1, . . . , p_A5) in the figure are estimated. During inference FIG. 3B, the estimated individual distributions may be used to construct the estimated joint distribution, then the observed actions may be used to estimate the unknown task and predict the future actions.

### Action Recognition and Time Extraction

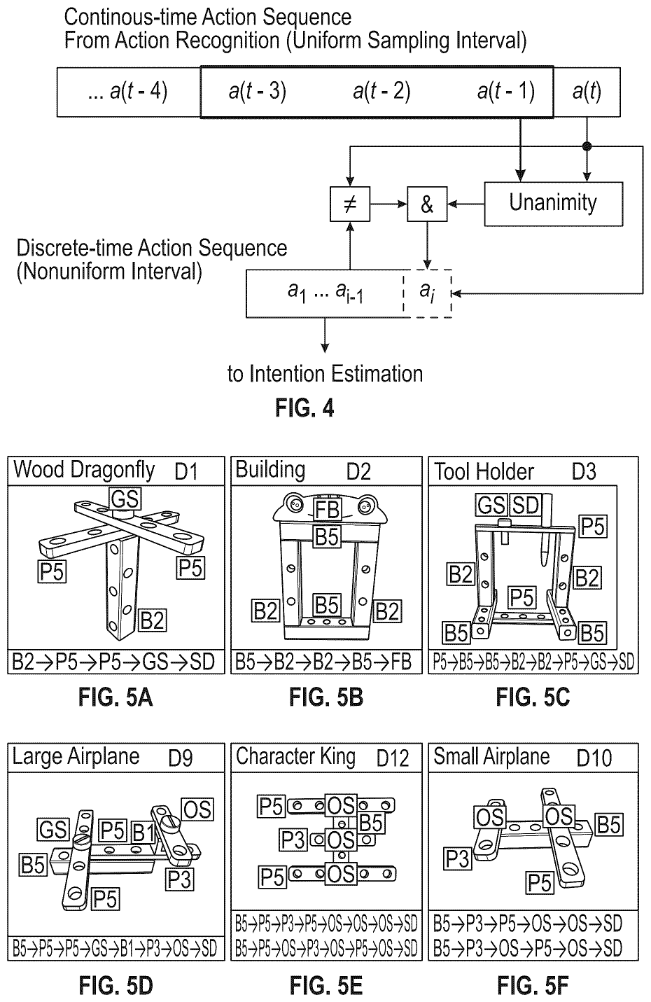

As a distinctive feature from the traditional HMM type of methods, the present method may explicitly model the individual distribution of all the actions, thus one may need to distinguish the actions and track their time of occurrence. One may assume there is an action recognition module that may output recognized actions in continuous time with uniform sampling intervals, such that the output may be the same during the execution of an action with sporadic recognition errors. One may then design an algorithm to extract the distinct actions from the recognized actions. The algorithm may slide a queue on the continuous time action sequence, only when an incoming action is in unanimity with all the actions in the queue and is different from the preceding extracted action, it may be extracted and appended to the extracted sequence. The logic used by the algorithm may be shown in FIG. 4. The larger the length of the queue, or the lag, the more robust the algorithm may be to the action recognition errors, at the expense of longer delay. The extracted sequence (a₁, . . . , aᵢ), denoted as the discrete-time action sequence, may then be fed into the inference models (9) and (10).

### EXPERIMENTS

### Setup

One may experiment with the proposed method on a toy assembly work. Six different tasks with their nominal action sequences may be shown in FIGS. 5A-5F. Each of the eight nominal action sequences may be chosen roughly equally likely by an operator as a task to complete. A total of 194 trials from 13 operators may be collected as a dataset. The action recognition module designed above may be reused for continuous-time action recognition. It may take vision and motion measurements as input and outputs recognized actions at 4 Hz sampling rate.

### Discrete-Time Action Sequence Extraction

First, one may test the discrete-time action sequence extraction proposed above. Three lags 3, 4 and 6, corresponding to delays of 0.75 s, 1 s and 1.5 s may be tested. The number of trials where the nominal action sequence cannot be correctly extracted may be summarized in Table I below. It may show that the nominal action sequences may be correctly extracted from the action recognition output with chances above 91%, 95% and 97% under the three lags. It may imply that with at least the same chance, an intention estimation model running on the extracted discrete-time actions may perform at least the same as running on the nominal action sequences. This may be corroborated with further experiments in the sequel.

| lag | 3 (0.75 s) | 4 (1 s) | 6 (1.5 s) |
|---|---|---|---|
| Fraction of trials | 17/194 | 9/194 | 5/194 |
| with extraction error | (8.7%) | (4.6%) | (2.6%) |

Motivated by this observation, one may also train the model solely based on the set of nominal action sequences.

### Task Estimation

Task distribution estimation: For task estimation, one may first examine the accuracy of estimated task distribution, using D1, D9 and D12 as examples. Note that D1 may be distinguished from other tasks by taking the first action on B2; whereas D9 and D12 may share the same first four actions, as they both act on B5 and P5 at the beginning; they may also share the first two actions with D2 and D10. This may cause the intrinsic uncertainty in task estimation, and the ground truth distributions may be calculated from the nominal action sequences assuming equal likelihood of their occurrence.

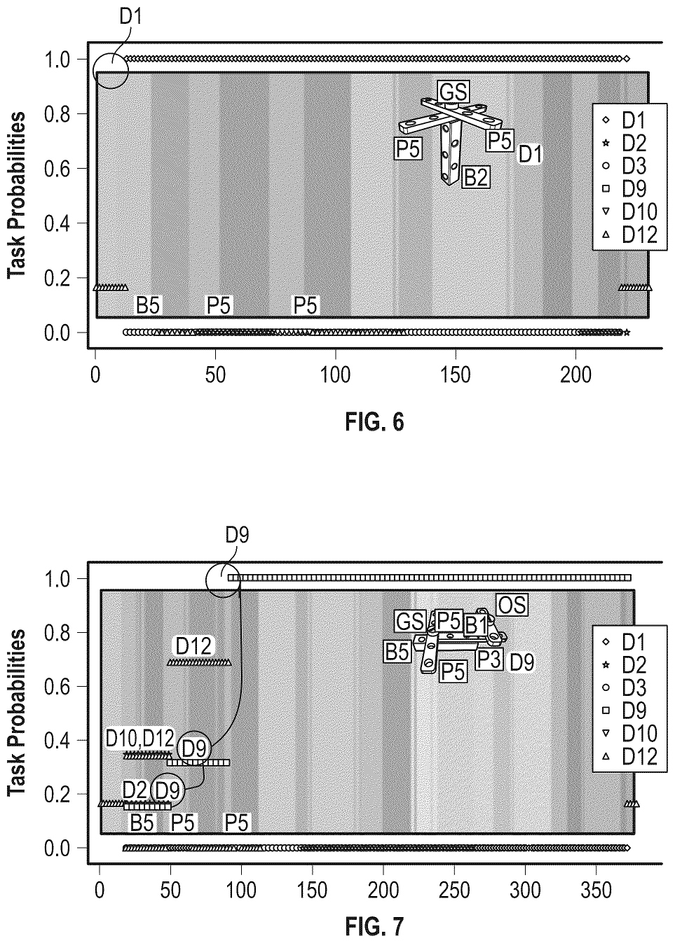

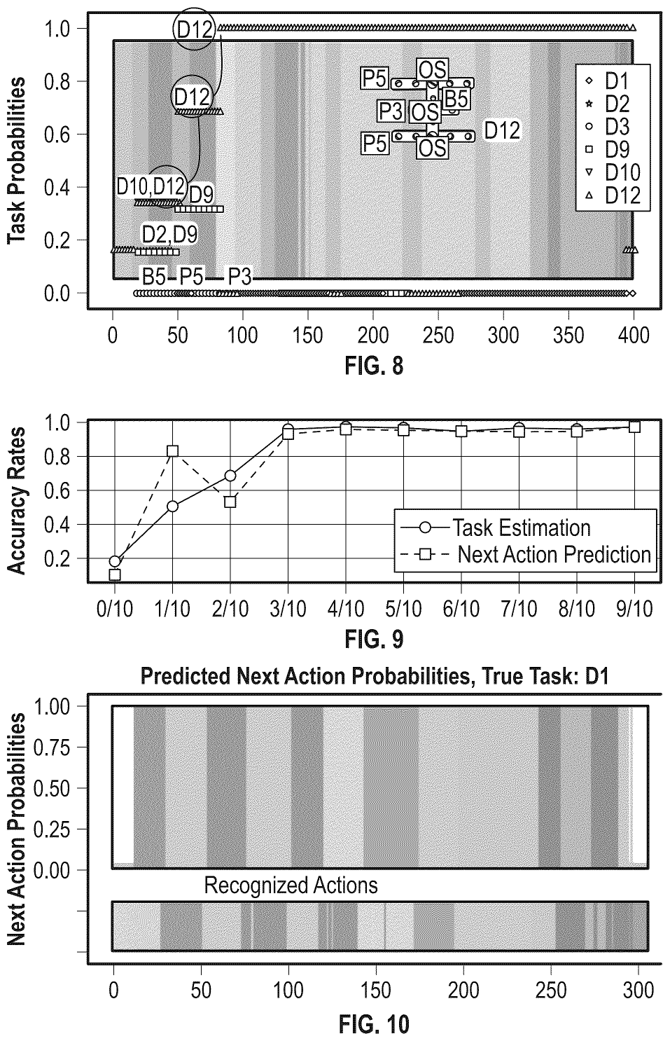

The estimated task distributions for three trials of D1, D9 and D12 may be shown in FIG. 6, FIG. 7 and FIG. 8. In these trials the nominal action sequences may be correctly extracted, and the model may accurately estimate the task distributions given the observed actions at all time instances. For example, in FIG. 6, P(T=D1|A₁=take B2)=1 may be correctly estimated; in FIG. 7, the task distributions

(11)

| T | D10 | D12 | D2 | D9 |
|---|---|---|---|---|
| P_{TIA1=take B5} | 1/3 | 1/3 | 1/6 | 1/6 |

(12)

| T | D12 | D9 |
|---|---|---|
| P_{TIA1=take B5, A2=place B5, A3=take P5} | 2/3 | 1/3 |

and P(T=D9| A₁=take B5, A₂=place B5, A₃=take P5, A₄=place P5, A₅=take P5)=1 may be accurately estimated; and in FIG. 8, the same distributions as in (11) and (12), and P(T=D12|A₁=take B5, A₂=place B5, A₃=take P5, A₄=place P5, A₅=take P3)=1 may be accurately estimated once the conditioning actions are observed. In summary, the conditional distributions P_{T|A1 . . . . Ai} for all i=1, . . . , n may be accurately estimated using (9), whenever the nominal action sequences are correctly extracted.

Task estimation accuracy: Although the model may accurately estimate the task distribution given observed actions, the most-likely estimate may not be the true task, as shown in FIG. 7 and FIG. 8. This may be due to the intrinsic ambiguities among the tasks, that is, the nominal action sequence of different tasks may have overlaps especially at the beginning, as discussed above. The overall accuracy rate of task estimation as a function of the fraction of observed actions may be plotted and shown in FIG. 9. One may see that as more actions are observed, the most-likely estimated task is more likely to be the true task. For the six toy assembly tasks under consideration, observing 3/10 of the actions may be enough to distinguish all tasks. This accuracy analysis may thus be helpful for one to quantify the ambiguity of the tasks as well.

Another observation is that with the proposed method, even observing the entire action sequence may not always be enough to correctly estimate the task, as the accuracy may saturate at around 97%. This may be caused by the errors in the discrete-time sequence extraction, which may be due to either the uncorrected action recognition errors, or the failure of the operator to follow the nominal action sequence. This is in correspondence with the results shown in Table I.

### Next Action Prediction

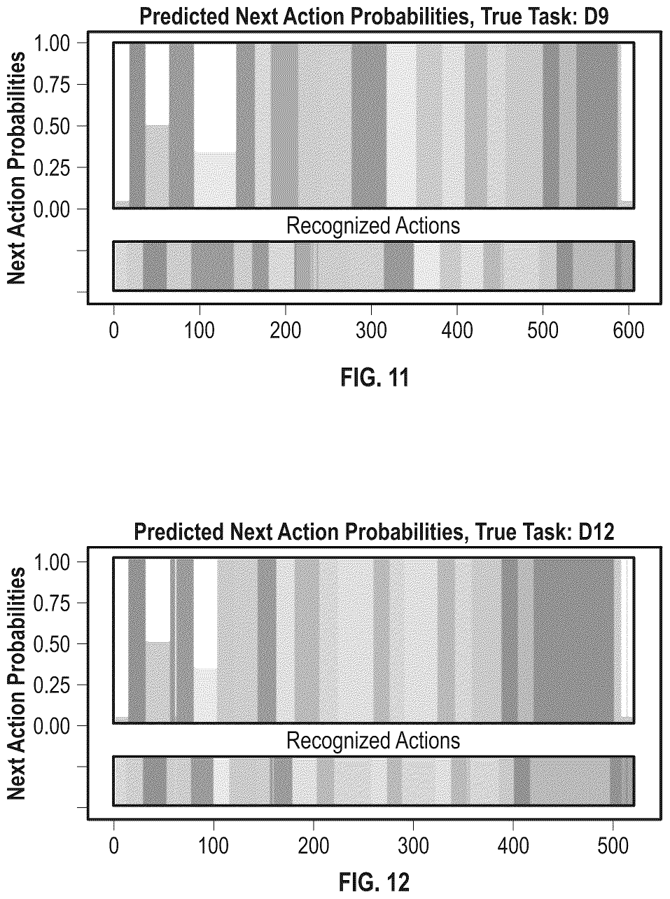

Next action distribution prediction: The predicted next action distributions for three trials of Task D1, D9 and D12 may be shown in FIG. 10, FIG. 11 and FIG. 12, where the nominal action sequences may be correctly extracted. One may see that the model may accurately predict the next action distributions given the observed actions at all time instances. For example, in FIG. 10, all the actions may be correctly predicted once A1=take B2 is observed; in FIG. 11, the distributions

$${P}_{A 2 \vert A 1 = take B 5} ( place P 5 ) = 1 \qquad ( 13 )$$

$${P}_{A 3 \vert A 1 = take B 5 , A 2 = place B 5} ( take P 5 ) = 1 / 2 \qquad ( 14 )$$

$${P}_{A 4 \vert A 1 = take B 5 , A 2 = place B 5 , A 3 = take P 5} ( place P 5 ) = 1 \qquad ( 15 )$$

$${P}_{A 5 \vert A 1 = take B 5 , A 2 = place B 5 , A 3 = take P 5 , A 4 = place P 5} ( take P 3 ) = 1 / 3 \qquad ( 16 )$$

may be accurately predicted once the conditioning actions may be observed, and all the future actions may be correctly predicted once (A₁=take B5, A₂=place B5, A₃=take P5, A₄=place P5, A₅=take P5) may be observed; in FIG. 12, one may see that the distributions may be the same as in (13)-(16) may also be accurately predicted, and all the future actions may be correctly predicted once (A₁=take B5, A₂=place B5, A₃=take P5, A₄=place P5, A₅=take P3) may be are observed. In summary, same as task estimation, the distributions P_{Ai+1|A1, . . . , Ai} for all i=1, . . . , n−1 may be accurately predicted using (10), whenever the nominal action sequences can be correctly extracted.

Next action prediction accuracy: The next action prediction accuracy rates vs. the fraction of observed actions may be shown in FIG. 9. Similar to task estimation, as more actions may be observed the prediction accuracy may increase due to better resolved task ambiguity, and the prediction performance may also be limited by the correctness of the extracted discrete-time action sequence. One may also see the action prediction accuracy may go higher than task estimation, which may be due to the fact that the next actions may be the same for different tasks.

Comparison with HMM Based Approach

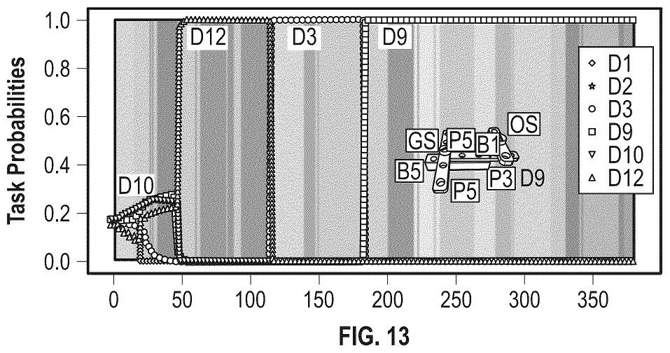

To compare with the HMM type of methods, one may use Pyro to implement an HMM based model for task estimation. The estimated task distributions from the HMM based model for a trial of D9 may be shown in FIG. 13. Compared with FIG. 7, one may see that the HMM may correctly estimate the task D9 only after the 10th action may be observed, and the distributions estimated before that point may all be incorrect; in contrast, the proposed method may output accurate distributions at all times, and may correctly estimates the task once the 5th action may be observed. The reason why HMM based methods cannot achieve the level of estimation accuracy achievable by the proposed method is that it may ignore the time information and applies the same model throughout the action sequence, unlike the much more refined model given by the proposed method. Another advantage of the proposed method is the capability of performing action prediction, which may not be easily achievable by HMM based methods, again due to the ignorance of time in such methods.

Comparison with Deep Learning Based Approach

The advantages of the proposed method to the HMM based methods may carry over to deep learning based methods, including accurate uncertainty estimation and future action prediction. The deep learning-based method may have some ability of action prediction by appropriate data annotation, but the prediction horizon may be limited to the immediate future action, e.g. within 1 or 2 seconds. By contrast, from FIG. 10 to FIG. 12 one may see that for just the next action prediction, the proposed method may already have a prediction horizon of 10 s of seconds; moreover, it may be able to predict all future actions, with accurate uncertainty estimations.

Another advantage of the proposed method may be that it is agnostic to the action recognition module and may use only the instruction manual for training, which may be a tiny amount of data. It may be easily adapted to changed or new tasks without retraining on the reannotated data, which may be costly but needed by the deep learning methods.

Utilizing the power and versatility of the PPL, one may propose a fine-grained probabilistic model for task and action level intention estimation for teleoperated assembly. The model may uniquely describe the distributions of the task and each action in the sequence in a time-varying manner, thus achieve accurate distribution hence uncertainty estimation of the task and future actions, given the actions taken so far. Additional advantages to HMM type of methods and deep learning-based methods may include the ability to predict future actions in much longer horizon, and the ease of adaptation to new tasks.

In order to tackle the problem of intention estimation in human-robot teleoperation for assembly tasks, which may include task estimation and action prediction, one may design a probabilistic graphical model to represent the joint distribution of the task and all the actions that need to be taken to complete the task. Both model learning and model inference may be implemented with Pyro, a state-of-the-art probabilistic programming language. The distinctive feature from the traditional HMM type of methods is that the present model may take the time information into account and explicitly models the individual distributions of all the variables under consideration. By doing this, one may utilize the power of probabilistic programming, and achieve accurate distribution hence uncertainty estimations. When working with a pretrained action recognition module, the proposed model may be trained solely on a tiny instruction manual of the assembly tasks. Moreover, whenever the instructions are changed or augmented, the proposed model may be retrained with negligible overhead, avoiding the need for the costly data reannotation and retraining by the pure deep learning based methods.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A method for probabilistic modeling for intention estimation in an operator-robot teleoperated assembly task, comprising:
estimating the assembly task to be completed, wherein the assembly task comprises a sequence of actions; and
predicting a next action of the sequence of actions to be performed for the assembly task to be completed.

2. The method of claim 1, comprising forming a probabilistic graphical model for estimating the assembly task and predicting the next action of the sequence of actions.

3. The method of claim 1, comprising forming a probabilistic graphical model to represent a joint distribution of the assembly task and all actions needed to be taken to complete the assembly task.

4. The method of claim 1, comprising forming a probabilistic graphical model to represent a joint distribution of the assembly task and all actions needed to be taken to complete the assembly task, wherein probabilistic graphical model learning is done through variation and probabilistic graphical model inference is done through structured marginalization.

5. The method of claim 1, comprising using a probabilistic programming language to form a probabilistic graphical model to represent a joint distribution of the assembly task and all actions needed to be taken to complete the assembly task, wherein probabilistic graphical model learning is done through variation and probabilistic graphical model inference is done through structured marginalization.

6. The method of claim 5, wherein the probabilistic programming language is Pyro.

7. The method of claim 2, comprising modeling individual distributions of the assembly task and all the actions taken at different times in completing the assembly task.

8. The method of claim 2, comprising using a pretrained action recognition module for training the assembly task.

9. The method of claim 3, comprising using a pretrained action recognition module for training the assembly task solely based on an instruction manual of the assembly task.

10. The method of claim 1, comprising:
treating the assembly task and the sequence of actions as jointly distributed random variables; and
constructing a joint distribution of the random variables, wherein the joint distribution of the random variables comprises a model structure and model parameters, wherein the model structure reflects dependencies among the random variables and determines how the joint distribution factorizes into a product of individual distributions of the random variables, and individual distribution of each random variable is one of a marginal distribution of a specific random variable when not influenced by other random variables, or a transition distribution conditional on random variables that influence the specific random variable, wherein the model parameters includes marginal distribution and all the transition distributions.

11. The method of claim 10, comprising learning the model parameters, wherein learning the model parameters comprises learning unknown individual distributions, from a dataset.

12. The method of claim 10, comprising:
representing each individual distribution as one of a single finite dimensional probability vector or multiple finite dimensional probability vectors, wherein each single finite dimensional probability vector and each multiple finite dimensional probability vectors are treated as random quantities; and
finding a posterior distribution of each single finite dimensional probability vector and each multiple finite dimensional probability vectors given the dataset.

13. The method of claim 12, wherein finding the posterior distribution of each single finite dimensional probability vector and each multiple finite dimensional probability vectors given the dataset is calculated in Pyro via stochastic variational inference (SVI).

14. The method of claim 10, comprising outputting recognized actions in continuous time with uniform sampling interval using an action recognition module, wherein the output is the same during execution of an action with sporadic recognition errors.

15. The method of claim 14, comprising extracting distinct actions from the recognized actions.

16. A method for probabilistic modeling for intention estimation in an operator-robot teleoperated assembly task, the method implemented using a computer system including a processor communicatively coupled to a memory device, the method comprising:
estimating the assembly task to be completed, wherein the assembly task comprises a sequence of actions;
predicting a next action of the sequence of actions to be performed for the assembly task to be completed; and
forming a probabilistic graphical model to represent a joint distribution of the assembly task and all actions needed to be taken to complete the assembly task, wherein probabilistic graphical model learning is done through variation and probabilistic graphical model inference is done through structured marginalization.

17. The method of claim 16, comprising forming the probabilistic graphical model using a probabilistic programming language, wherein the probabilistic programming language is Pyro.

18. The method of claim 16, comprising modeling individual distributions of the assembly task and all the actions taken at different times in completing the assembly task.

19. The method of claim 16, comprising using a pretrained action recognition module for training the assembly task solely based on an instruction manual of the assembly task.

20. A method for probabilistic modeling for intention estimation in an operator-robot teleoperated assembly task, comprising:
estimating the assembly task to be completed, wherein the assembly task comprises a sequence of actions;
predicting a next action of the sequence of actions to be performed for the assembly task to be completed;
treating the assembly task and the sequence of actions as jointly distributed random variables;
constructing a joint distribution of the random variables, wherein the joint distribution of the random variables comprises a model structure and model parameters, wherein the model structure reflects dependencies among the random variables and determines how the joint distribution factorizes into a product of individual distributions of the random variables, and individual distribution of each random variable is one of a marginal distribution of a specific random variable when not influenced by other random variables, or a transition distribution conditional on random variables that influence the specific random variable, wherein the model parameters includes marginal distribution and all the transition distributions;
representing each individual distribution as one of a single finite dimensional probability vector or multiple finite dimensional probability vectors, wherein each single finite dimensional probability vector and each multiple finite dimensional probability vectors are treated as random quantities;
finding a posterior distribution of each single finite dimensional probability vector and each multiple finite dimensional probability vectors given the dataset, wherein finding the posterior distribution of each single finite dimensional probability vector and each multiple finite dimensional probability vectors given the dataset is calculated in Pyro via stochastic variational inference (SVI);
outputting recognized actions in continuous time with uniform sampling interval using an action recognition module, wherein the output is the same during execution of an action with sporadic recognition errors; and
extracting distinct actions from the recognized actions.
